(19) United States
(12) Patent Application Publication
(10) Pub. No.: US 2025/0317353 A1
(43) Pub. Date: Oct. 9, 2025

(54) METHODS, APPARATUSES AND SYSTEMS RELATED TO PER-SERVICE OPERATION ENERGY CONSUMPTION

(71) Applicant: InterDigital Patent Holdings, Inc., Wilmington, DE (US)

(72) Inventors: Michael Starsinic, Newtown, PA (US); Michelle Perras, Montréal (CA); Saad Ahmad, Montréal (CA); Samir Ferdi, Kirkland (CA); Ulises Olvera-Hernandez, Saint-Lazare (CA); Achref Methenni, Montréal (CA)

(21) Appl. No.: 18/625,450

(22) Filed: Apr. 3, 2024

(51) Int. Cl. H04L 41/0833; H04L 41/12

(52) U.S. Cl. CPC H04L 41/0833; H04L 41/12

(57) ABSTRACT

In an embodiment, a method implemented in a first network function (NF) node, comprises transmitting, to a network repository function (NRF) node, a discovery request message comprising first information indicating one or more service operations related to NFs to be discovered; receiving, from the NRF node, a discovery response message comprising second information indicating one or more discovered NFs, and energy consumption information respectively associated with the one or more service operations of each of the one or more discovered NFs; determining a discovered NF among the one or more discovered NFs based on the energy consumption information respectively associated with the one or more service operations of each of the one or more discovered NFs; and transmitting, to a second NF node of the determined discovered NF, a first request message for the one or more service operations.

### FIELD OF THE INVENTION

The present disclosure is generally directed to methods and procedures related to per-service operation energy consumption. More particularly, the present disclosure relates to example solutions that enable a discoverer network function to discover information about the energy consumption that of invoking service operations of network function instances.

### BACKGROUND

It is known that when network functions perform a registration operation with a network repository function (NRF), the network functions may provide a network function (NF) profile to the NRF. The NF profile may include energy information about the NF. Examples of energy consumption information may include any of: (i) the percentage of the NF's energy consumption that uses renewable sources, (ii) energy states that the NF may utilize, (iii) the amount of energy consumption by the NF over a time window, (iv) a criteria that may be used to calculate the energy efficiency level of the NF, and (v) a level value that may represent a restriction on the energy consumption allowed for the NF over the time window.

A first NF may send a discovery request to the NRF. The discovery request can indicate the type of NF that the first NF wants to discover. The NRF can send a response message to the first NF. The response message can include one or more NF profiles. Each NF profile may provide information about an NF that matches the criteria (e.g., NF type) that the first NF provided in the discovery request. The one or more NF profiles that the NRF transmit to the first NF may include the energy consumption information in the NF Profiles. The first NF can then consider the energy consumption when the first NF selects which NF it wants to interact with.

A normalized energy consumption and energy consumption may be part of the NF profile. This value would be helpful, for example, in a situation where the NF consumer may prefer to select an NF whose energy consumption is currently low.

An energy efficiency level performance metric may be part of the NF profile. This value would be helpful, for example, in a situation where the NF consumer may prefer to select an NF that is efficient (e.g., the NF consumer prefers efficiency over some other criteria).

The energy consumption information that is provided to the first NF, and used for NF selection, represents information about total energy consumption of the discovered NF. This may be useful to the first NF if the first NF is configured to preferably select NFs that are less loaded e.g., NFs that consume less energy) or if the first NF is configured to preferably select NFs that consume renewable energy. However, said energy consumption information that is provided to the first NF is not useful in scenarios where the first NF prefers to select an NF that will consume less overall energy when executing specific services that the first NF will need to invoke of the selected NF.

There is a need to enhance the energy consumption information provided to NFs.

### SUMMARY

In an embodiment, a method, implemented in a first network function (NF) node, may comprise a step of transmitting, to a network repository function (NRF) node, a discovery request message comprising first information indicating one or more service operations related to NFs to be discovered. The method may further comprise a step of receiving, from the NRF node, a discovery response message comprising second information indicating one or more discovered NFs, and energy consumption information respectively associated with the one or more service operations of each of the one or more discovered NFs. The method may further comprise a step of determining a discovered NF among the one or more discovered NFs based on the energy consumption information respectively associated with the one or more service operations of each of the one or more discovered NFs; and a step of transmitting, to a second NF node of the determined discovered NF, a first request message for the one or more service operations.

The transmitted first request message may comprise third information indicating an energy consumption information associated with the one or more service operations of the discovered NF. In response to the transmitted first request message, the method may comprise a step of receiving, from the second NF node of the discovered NF, a first response message comprising fourth information indicating a number of credits associated with the energy consumption information associated with the one or more service operations of the discovered NF.

Alternatively, in response to the transmitted first request message, the method may comprise a step of receiving, from the second NF node of the discovered NF, a second response message comprising sixth information indicating that the energy consumption information associated with the one or more service operations of the discovered NF is out of date; and a step of transmitting, to the NRF node, a second request message for an update of the energy consumption information associated with the one or more service operations of the discovered NF.

The method may further comprise a step of transmitting to the NRF node, a message comprising information indicating a request for a subscription to receive notifications from the NRF node when the energy consumption information associated with the one or more service operations of the discovered NF changes.

The first NF node may comprise an access and mobility management function (AMF) or a session management function (SMF). The discovered NF function of the second NF node may be a user plane function or a SMF.

The second information may indicate NF profiles respectively associated with the one or more discovered NFs; and wherein determining the discovered NF among the one or more discovered NFs may be further based on the NF profiles respectively associated with the one or more discovered NFs. The NF profiles respectively associated with the one or more discovered NFs may comprise the identities of the one or more discovered NFs.

The energy consumption information respectively associated with the one or more service operations of each of the one or more discovered NFs may correspond to an estimate of the energy consumption that will result when the one or more service operations of a discovered NF of the one or more discovered NFs is invoked.

In an embodiment, a first network function (NF) node, may be configured to transmit, to a network repository function (NRF) node, a discovery request message comprising first information indicating one or more service operations related to NFs to be discovered. The first NF node may be configured to receive, from the NRF node, a discovery response message comprising second information indicating one or more discovered NFs, and energy consumption information respectively associated with the one or more service operations of each of the one or more discovered NFs. The first NF node may be configured to determine a discovered NF among the one or more discovered NFs based on the energy consumption information respectively associated with the one or more service operations of each of the one or more discovered NFs; and to transmit, to a second NF node of the determined discovered NF, a first request message for the one or more service operations.

In another embodiment, a method, implemented in a first network function (NF) node, may comprise a step of receiving, from a second NF node, a first request message for a service operation, the first request message comprising first information indicating a first energy consumption information associated with the service operation. The method may further comprise a step of transmitting to a charging function (CHF) node the first request message. The method may further comprise a step of receiving, from the CHF node, a first response message comprising second information indicating a number of credits related to the first energy consumption information associated with the service operation of the first NF; and a step of transmitting, to the second NF node, a first message comprising third information indicating the number of credits related to the first energy consumption information associated with the service operation of the first NF.

The method may further comprise a step of receiving, from the second NF node, a second message comprising fourth information indicating a second energy consumption information associated with the service operation, wherein the second energy consumption information differs from the first energy consumption information; and a step of transmitting, to the second NF node, a third message comprising fifth information indicating that second energy consumption information is out of date.

### BRIEF DESCRIPTION OF THE DRAWINGS

A more detailed understanding may be from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a signaling diagram illustrating an example of a network function registration procedure according to one embodiment;

FIG. 3 is a signaling diagram illustrating an example of a network function discovery procedure according to one embodiment;

FIG. 4 is a signaling diagram illustrating an example of a registration, discovery, selection, and invocation of network functions according to an embodiment;

FIG. 5 is a flow chart diagram illustrating an example of a method, implemented in a network function node, for discovering a network function according to an embodiment; and

FIG. 6 is a flow chart diagram illustrating an example of a method, implemented in a first NF node for indicating, to a second NF node, charge for a service operation according to another embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’.

A sign, symbol, or mark of forward slash ‘/’ is to be interpreted as ‘and/or’ unless particularly mentioned otherwise, where for example, ‘A/B’ may imply ‘A and/or B’.

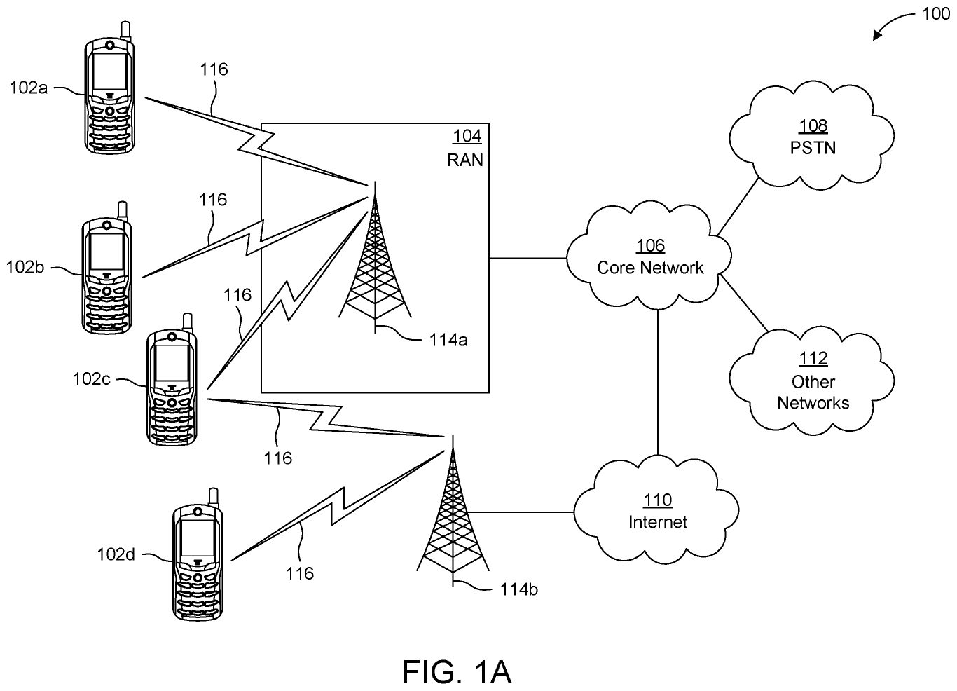

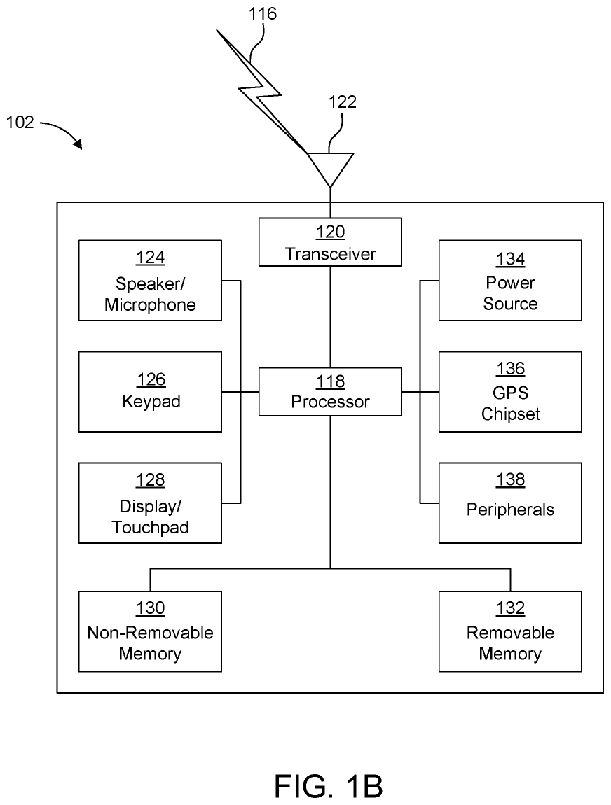

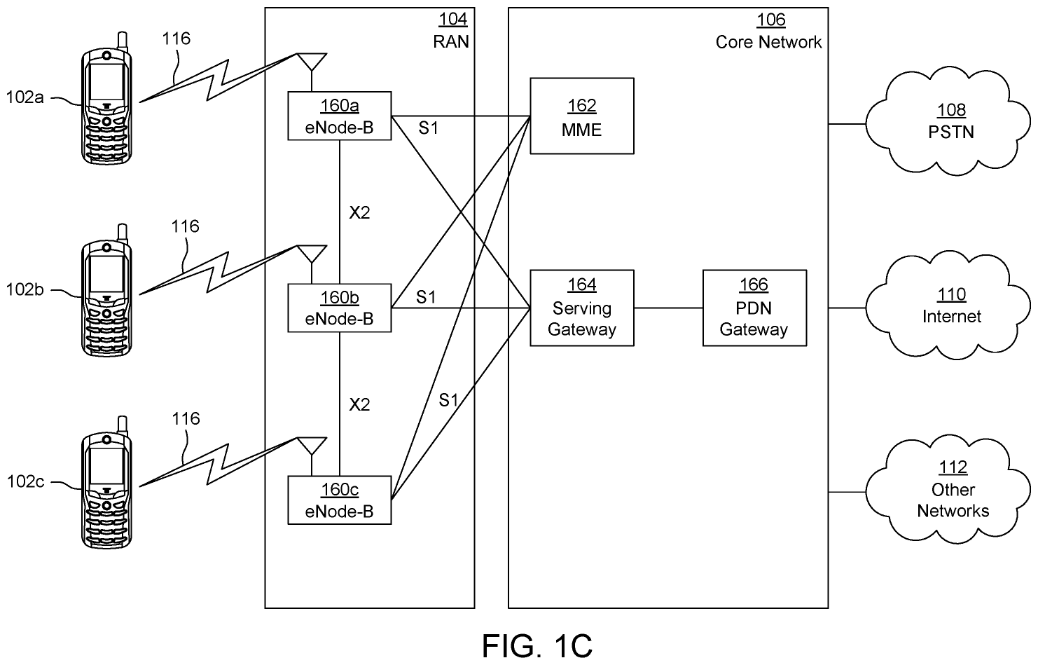

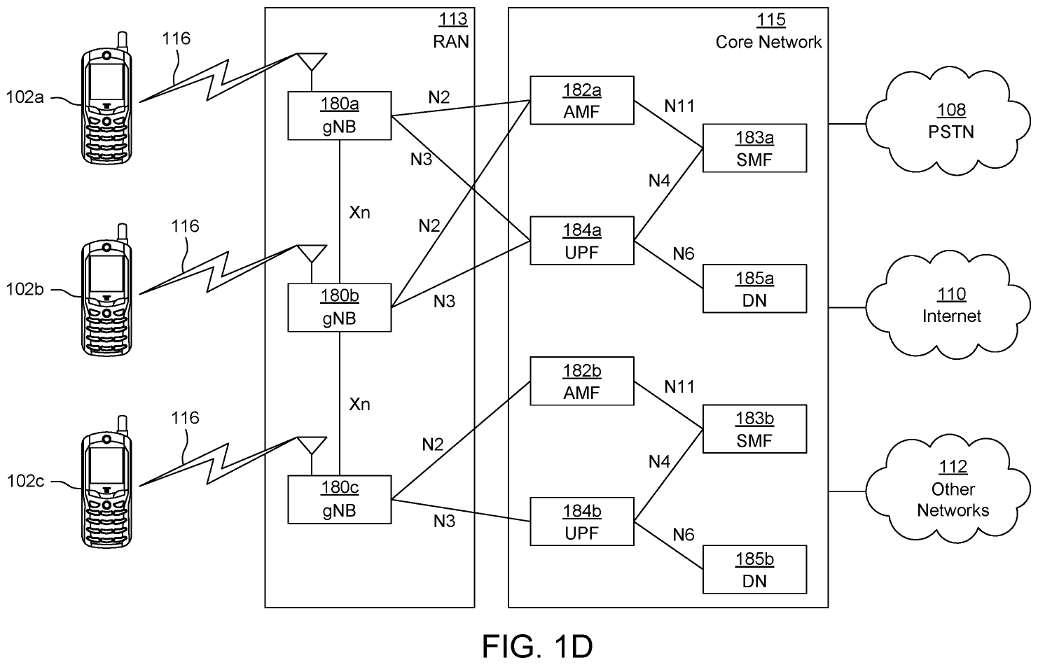

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signalling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications, such as machine-type communications devices in a macro coverage area. Machine-type communications devices may have certain capabilities, for example, limited capabilities including support for (e.g., only support for) certain and/or limited bandwidths. The machine-type communications devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one access and mobility management function (AMF) 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signalling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device (e.g., a network node) may be directly coupled to another device for purposes of testing and/or may performing testing using over-the-air wireless communications.

The one or more emulation devices may perform the one or more, including all, functions while not being implemented/deployed as part of a network node (e.g., wired and/or wireless communication network). For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The energy consumption that is associated with an NF may be highly dependent on what service operations of the NF are invoked. When an NF performs a NF selection, it may likely prefer to get an NF that consumes relatively little energy for service operations that are likely to be invoked. The various embodiments below relate to a per-service level energy consumption information that may provide more granularity and flexibility in the process of energy aware NF selection.

In various embodiment below, the term network function (NF) is interchangeable referred as a network function node, wherein an NF may be implemented in one or more NF nodes. In various embodiments below, the term network repository function (NRF) is interchangeable referred as a network repository function node. In various embodiments below, the term charging function (CHF) is interchangeable referred as a charging function node, wherein a charging function may be implemented in one or more charging function nodes.

Various embodiments below relate to example solutions that enable a (e.g., discoverer) NF to obtain (e.g., discover) information about an energy consumption that of invoking service operations of NF instances. The (e.g., discoverer) NF may use the information about the information energy consumption of the requested services operation of NF instances to select an NF instance and invokes the service operations of the NF instance. When the services of the NF instance, the NF instance can detect if the (e.g., discoverer NF) has not considered up to date energy consumption information. The NF instance may then trigger the (e.g., discoverer NF) to fetch new energy consumption information.

Various embodiments below relate to example solutions that enable an NF instance to provide energy consumption information about the NF instance to the NRF. Later, when a (e.g., discoverer) NF invokes/requests a service of the NF instance, the (e.g., discoverer) NF may indicate what energy consumption information the (e.g., discoverer) NF considered. If the energy consumption information is not up to date, the NF instance may then trigger the (e.g., discoverer) NF to obtain (e.g., fetch) new energy consumption information.

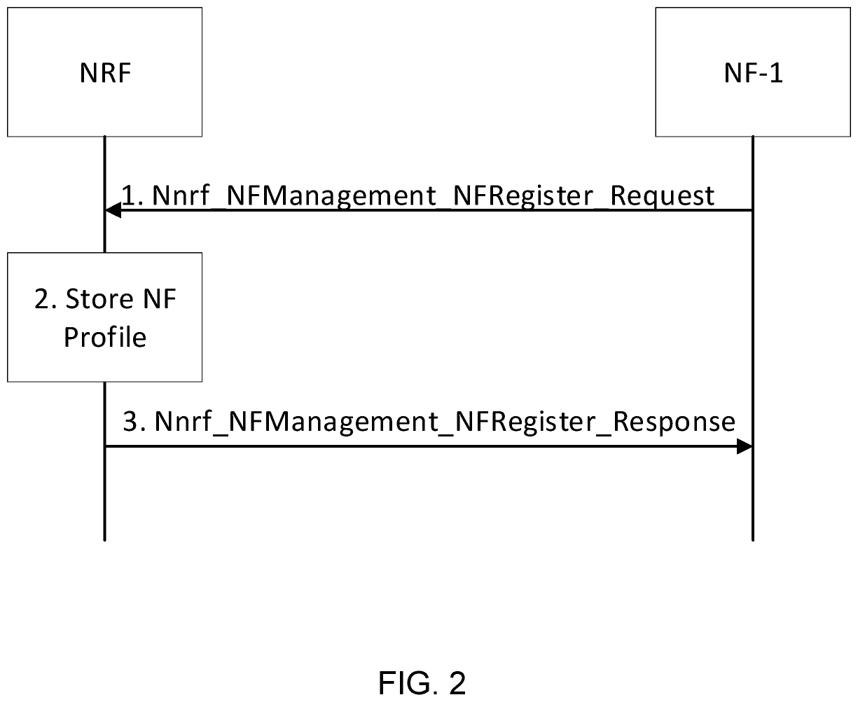

Referring to FIG. 2, an example procedure for how an NF may register with the NRF is shown. The NF (NF-1) may be triggered to initiate the registration procedure when the NF becomes operative (e.g., when the NF is instantiated). The NF (NF-1) may transmit its NF profile to the NRF in the registration request (Nnrf_NFManagement_NFRegister_Request). The NF profile transmitted to the NRF may comprise the NF (NF-1) identity (NF-1_ID). The NF may initiate a similar procedure when it needs to update information in the NF Profile.

In step 1 of FIG. 2, the NF may transmit an Nnrf_NFManagement_NFRegister Request message to the NRF. The message may include information indicating the NF profile. The NF profile may include per service energy consumption information. For example, the NF may offer one or more services. The NF profile may include energy consumption information for each service that the NF offers. The energy consumption information that is related to each service may be called a service specific energy consumption estimate. Each service specific energy consumption estimate may be expressed as a number of energy credit units, a number of Watts, or a number of Joules.

The service specific energy consumption estimate may represent an estimate of the energy consumption that is associated with invoking the associated service. The service specific energy consumption estimate may represent an estimate of the amount of energy that will be consumed by the NF when the service is invoked.

Alternatively, the service specific energy consumption estimate may represent an estimate of the associated amount of energy that will be consumed by a 5GC when the service is invoked. When the service specific energy consumption estimate represents an estimate of the amount of energy that will be consumed by the 5GC, the service specific energy consumption estimate may include an estimate of the energy that will be consumed by the NF and will be consumed by other NFs (e.g., as individual values or as an aggregate value) that will be triggered to perform actions in order to execute the service.

The service specific energy consumption estimate may include multiple values and each value can represent an estimate of the energy consumption that is associated with invoking a service operation of an associated service. For example, the units of a value may be Joules or energy credits. The value may represent the energy cost that is associated with invoking one service operation. For example, the value may indicate the number of Joules, or energy credits, that are associated with invoking the Nsmf_PDUSession_TransferMTData service operation. The value may be calculated based only on the energy that is expended by the NF that exposes the service or the value may be calculated based on the total energy that will be consumed in the operator's network when the service is invoked (e.g., the value may include the energy consumption that takes place in other NFs due to the service being invoked).

The service specific energy consumption estimate may be an estimate of the energy consumption that will result when each service operation of the NF is invoked (e.g. the units can be Joules or energy credits).

Nsmf_PDUSession may be an example of an NF Service. Nsmf_PDUSession may be a service that is offered by an SMF. Create, update, TransferMOData, and ContextPush may be examples of service operations that are associated with the Nsmf_PDUSession service.

The service specific energy consumption estimate that is associated with invoking a service operation may include multiple values and each value can represent an estimate of the energy consumption that is associated with invoking a service operation of an associated service when an optional parameter is provided in the service invocation or when a parameter is set to a certain value or range in the service invocation.

“Estimated Maximum Wait time” may be a parameter that can optionally be provided to the SMF when the Nsmf_PDUSession_TransferMTData service operation is invoked. The amount of energy that is consumed when the Nsmf_PDUSession_TransferMTData service operation is invoked may depend on whether an “Estimated Maximum Wait time” parameter is provided to the SMF and the value of the “Estimated Maximum Wait time” parameter. This is because the “Estimated Maximum Wait time” may influence whether and how long the SMF buffers the MT Small Data that is provided when the service operation is invoked.

For some network functions services, some service operations may incur one sequence of actions by the NF with one service operation invocation, such as a Request/Response type of service operation.

Other service operations such as a Subscribe/Notify service operations may incur repetitive actions performed by the NF. For example, if a NF subscribed to event notifications, either periodically or based on an event, then the NF producer will execute a set of actions either periodically in some way (either with respect to a periodic notification, or whenever a certain event occurs, which may happen more than once). In this case, the NF may include a per service energy consumption for an atomic service operation, which represents one occurrence of the set of actions that the NF producer may perform.

Per service energy consumption for an atomic service operation may be based on a predication of the frequency at which notifications will need to be sent in response to a subscription request. The frequency at which notifications will be send may be used to derive overall energy consumption information.

In other scenarios, the energy consumption of a certain service operation offered by a network function NF-2 to a consumer network function NF-1, and to perform this service operation NF-2 will solicit other NFs, for example an NF-3 for other service operations, then the NF energy profile for NF-2 may include information about the per service operation energy consumption for local processing at NF-2, and an indication that another portion of energy consumption will be used due to the invocation by NF-2 of another NF services, such as NF-3.

In this case, NF-2 may provide the NF energy profile or an NF energy profile template, which has information about local energy consumption related to each service and service operations, and may have some information that is dependent on other NFs and this energy consumption information may only be available once NF-2 have perform an NF-3 NF selection.

This will not impact the NF selection of NF-2 by NF-1. Once NF-2 has selected NF-3, an energy profile instance may be assigned to NF-2 associated with selected network function NF-3, with the values for energy consumption related to NF-3 populated, since the NF-3 is now selected.

In an example, an AMF may perform SMF selection, and it may use the SMF energy profile template that is available at the NRF. Such an energy profile template may have value SMF: service operation 1: Local Energy consumption A, Energy Consumed by subsequent UPF, depend on the Selected UPF.

Once the SMF performs UPF selection, to serve a certain PDU session, the SMF may use the information in the UPF energy profile/energy profile instance, to create an energy profile instance or populate its energy profile instance, for the AMF. The Energy profile instance may be stored locally at the SMF or AMF, for example within an SMF context.

The SMF energy profile instance, which has all the energy consumption information (including the selected UPF energy information) can be provided to the charging function (CHF), with a certain instance ID together with SMF ID and PDU session ID, to allow an accurate tracking of the energy usage of the SMF and AMF and so on.

In step 2 of FIG. 2, the NRF stores the NF profile information that was received in step 1.

The NF profile information may be stored with an NF profile version value. The NF profile version value of an NF profile may be assigned by the NRF in this step. The NF profile version value may be changed by the NRF each time the NF profile version changes (e.g., each time the NF (re) registers its NF profile).

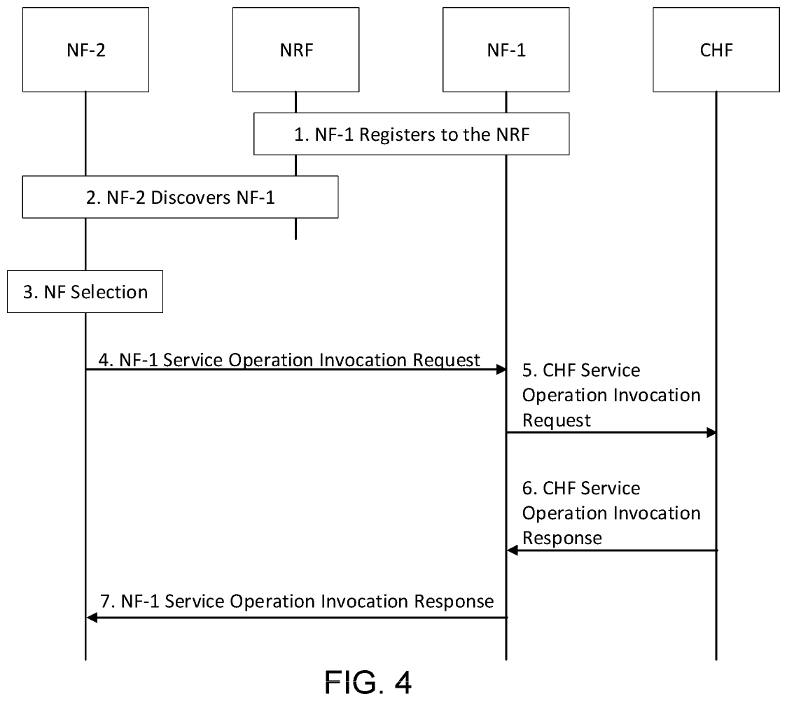

The NF profile version value may be provided to service consumers when they receive NF profile information (e.g. during a discovery operation). NF consumers of the NRF may use the NF profile version value. For example, NF consumers that receive service specific energy consumption estimate information associated with a discovered NF can provide the NF profile version value to the discovered NF when a service is invoked. The NF profile version value can be sent to a CHF by the discovered NF (e.g. NF-1 in FIG. 4) so that the value can be stored in a charging data record (CDR). Since the NF profile version value is associated to a particular service specific energy consumption estimate information, the charging system would know how many energy credits to charge for the service invocation.

In step 3 of FIG. 2, the NRF acknowledges the request of step 1 (FIG. 2) by transmitting an Nnrf_NFManagement_NFRegister response message to the NF.

The response may include the NF profile version value. Later, when a service of the NF is invoked and the service invoker provides the NF profile version value, the NF can check that the NF profile version value is current. If it is not current, the NF would be able to send a message to the service invoker that indicates that the NF profile version value is out of date. The message may further comprise information indicating that a new service specific energy consumption estimate information should be fetched. The NF consumer may request to the NRF an update on the specific energy consumption estimate associated with the NF.

Alternatively, the NF consumer may subscribe to the NRF, for example after NF selection or NF discovery procedures, to receive notifications from the NRF when the NF profile version changes. In this scenario, the NF consumer can use the Nnrf_NFManagement_NFStatusSubscribe service operation to receive such an update.

As described in FIG. 2, a NF may provide its energy consumption estimate information to the NRF when the NF registers to the NF. Alternatively, the NRF may obtain the energy consumption estimate information from a NF such as an energy efficiency control function (EECF). The NRF may obtain the energy consumption estimate information after the NF registers to the NRF. The NF may provide its NF profile to the EECF before registering with the NRF. The NF profile may comprise the NF identity (NF_ID).

Alternatively, the NF (e.g., NF-1 in FIG. 2) may be the one assigning a version value to its profile. In this case, the registration message at step 1 (in FIG. 2) includes an NF profile version value. As previously indicated, the registration message may include the NF profile or the NRF may query the EECF and may provide the version value as received from the NF.

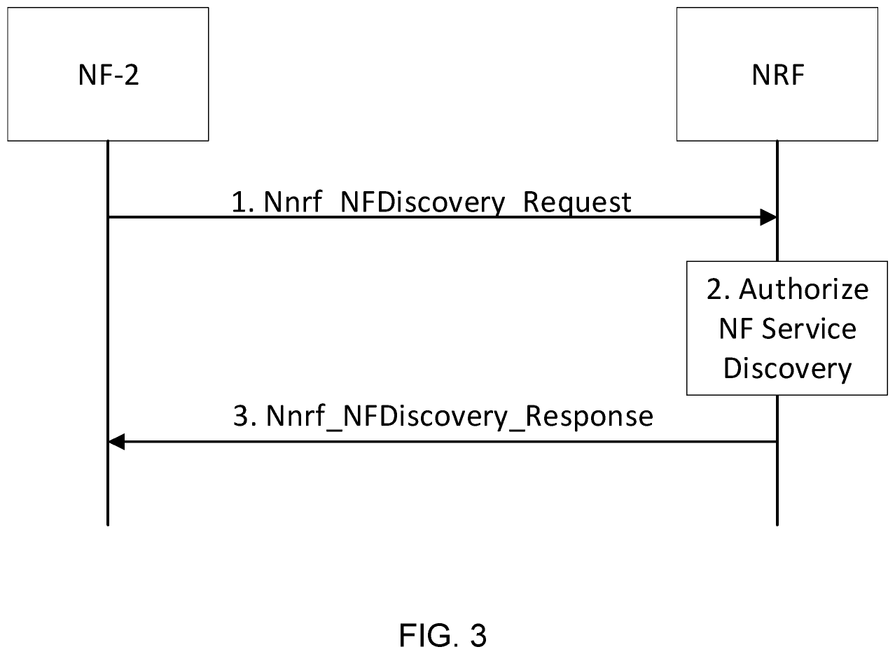

About NF discovery, referring to FIG. 3, an example procedure for how an NF may discover information about other NFs from the NRF is shown. The NF may be triggered to initiate the discovery procedure when the NF needs to select another NF to participate in a procedure. The NF indicates the type of the other NF that it needs to discover to the NRF in the discovery request.

Referring to FIG. 3, in step 1, a consumer NF (NF-2) may transmit an NF discovery request message to the NRF, for example, by invoking the Nnrf_NFDiscovery_Request service operation. The NF discovery request message may comprise information including a type of NF that the (e.g., consumer) NF (NF-2) wants to discover.

The discovery request message may comprise information indicating what services and what service operations the (e.g., consumer) NF plans on invoking of whatever NF the (e.g., consumer) NF (NF-2) may (e.g., eventually) select. The discovery request message may also comprise information indicating what optional inputs the (e.g., consumer) NF (NF-2) plans on providing when the (e.g., consumer) NF (NF-2) invokes service operations.

In step 2, the NRF may authorize the request of step 1. For example, the NRF may authorize the (e.g., consumer) NF (NF-2) based on a pre-provisioned certificate or information from an operations, administration and maintenance (OAM) system. The information from the OAM system or certificate may indicate which network functions the (e.g., consumer) NF is authorized to discover.

In step 3, the NRF may sends a Nnrf_NFDiscovery_Response message to the (e.g., consumer) NF. The Nnrf_NFDiscovery_Response message may include information indicating the NF profile. The Nnrf_NFDiscovery_Response message may include information indicating the service specific energy consumption estimate information. The Nnrf_NFDiscovery_Response message may include information indicating the NF profile version value. The NF profile, the service specific energy consumption estimate information and the NF profile version value are for the discovered NFs.

Alternatively, the response of step 3 may include no service specific energy consumption estimate information. In such case, the consumer NF may query a network data analytics function (NWDAF) and may provide the identities of discovered NF's and the NWDAF may provide the service specific energy consumption estimate information to the consumer NF. The identities of the discovered NF may be part of the NF profiles of the discovered NF.

Alternatively, the response of step 3 might include an estimated energy consumption over a time window. The NRF may calculate, or base, the estimate on information that was provided to the NR in step 1. For example, the NRF may calculate, or base, the estimate on what services and what service operations the (e.g., consumer) NF (NF-1) plans on invoking. For example, the NRF may calculate, or base, the estimate on what optional inputs the (e.g., consumer NF plans on providing when the (e.g., consumer) NF invokes service operations.

About a combined procedure, referring to FIG. 4, an example procedure wherein a first NF e.g., NF-1) may register to the NRF and a second NF (e.g., NF-2) may performs a discovery procedure with the NRF. During the discovery procedure, the second NF (NF-2) may receive an NF profile of the first NF (NF-1), from the NRF. The NF profile of the first NF (NF-1) may comprise an identifier of the first NF (NF-1). The second NF (NF-2) may select the first NF (NF-1) and invokes a service operation of the first NF (NF-1).

The description of FIG. 4 explains how the service specific energy consumption estimate information can be used during an NF selection procedure. The description of FIG. 4 may also show how the NF profile version value can be used to charge energy credits when a service operation of the first NF (NF-1) is invoked.

More particularly, in step 1 of FIG. 4, the first NF (NF-1) and the NRF may perform a registration procedure as describe above and illustrated at FIG. 2. As described above, the first NF that registers (NF-1) may transmit its service specific energy consumption estimate to the NRF. The NRF may also provide an NF profile version value to the first NF (NF-1). Alternatively, the NF (NF-1) may provide its NF profile version value to the NRF.

As explained above, the first NF (NF-1) may trigger the registration procedure when the first NF (NF-1) is instantiated or activated. Alternatively, the first NF (NF-1) can perform a registration update procedure with the NRF. The purpose of the registration update may be to update the NF Profile of the first NF (NF-1). The first NF (NF-1) may trigger the registration update procedure when the configuration of the first NF (NF-1) changes.

In step 2, the second NF (NF-2) and the NRF may perform a discovery procedure as describe above and illustrated at FIG. 3. During the discovery procedure, the second NF (NF-2) may receive one or more NF profiles respectively of one or more NFs (e.g., NF-1), the service specific energy consumption estimate information of one or more NFs (e.g., NF-1) and the NF profile version value of the one or more NFs (e.g., NF-1). The one or more NF profiles may respectively comprise identifier of the one or more NFs e.g., NF-1).

In step 3, the second NF (NF-2) may determine to select the first NF (NF-1). Selecting the first NF (NF-1) means that the second NF (NF-2) may determine to invoke one or more service operations of the first NF (NF-1). The second NF (NF-2) may make this determination based on the content of NF-1's NF profile and the service specific energy consumption estimate information of the first NF (NF-1). For example, the second NF (NF-2) may determine that the amount of energy credits that will be charged when a service operation of the first NF (NF-1) is within a range that is acceptable to the second NF (NF-2).

In step 4, the second NF (NF-2) may transmit a request message indicating a service operation of the first NF (NF-1). The request message from the second NF (NF-2) to the first NF (NF-1) may include the NF profile version value.

In step 5, the first NF (NF-1) may perform actions based on the request message. the First NF (NF-1) may transmit the request message to the CHF. The message to the CHF indicates that the second NF (NF-2) invoked the service operation and the message to the CHF may include the NF profile version value (if the NF profile version value was received from NF-1). The message to the CHF may also include a correlation ID or a transaction ID to allow the CHF to trace the service operation request/invocation to multiple NFs. For example, if the second NF (NF-2) invoked/requested the first NF (NF-1) for a certain service operation, which in turn invoked NF-0 for a service operation related or triggered by the first service operation invocation, then a common transaction ID for both service operations may allow the CHF to associate NF-0 service operation invocation to NF-1 and also NF-2, and use for charging it depending on the charging policies or for data record.

Alternatively, the first NF (NF-1) may determine that the NF profile version value represents an old NF profile. If the first NF (NF-1) determines that the second NF (NF-2) is using an old NF profile, then the first NF (NF-1) may decide to perform no operations based on the service invocation message and instead may reply to the second NF (NF-2) with an indication that the NF profile version value is not current, and that the second NF (NF-2) should obtain a new NF profile for the first NF (NF-1). The indication that the NF profile version value is not current, and that NF-2 should obtain a new NF profile for the first NF (NF-1) may be sent to the second NF (NF-2) in step 7.

In step 6, the CHF may acknowledge the request of step 5.

In step 7, the first NF (NF-1) may respond the service (e.g., invocation) request of step 4. The response may include an indication of whether the service operation was successfully executed and how many energy credits the second NF (NF-2) will be charged for the service request/invocation. The response may alternatively indicate that the service operation was not successfully executed, that the NF profile version value that was provided is not current, and that the second NF (NF-2) should obtain a new NF profile for the first NF (NF-1).

In some scenarios, for example, for a Subscribe/Notify type of service operation, multiple consumer NFs may subscribe to event notifications, and the same set of actions will be performed for the same subscriptions of the different NFs. The NF producer will send a notification to the NFs once an event is detected. In this case, the NF producer may associate an energy credit to the service operation for each of the NF consumers. Alternatively, the NF producer may associate, e.g., by sending an energy information to the CHF, a portion of the energy consumption incurred by the service operation, by considering the number of NFs that are subscribing to this service operation. For example, if 10 NFs subscribed to a service operation, and the Energy consumed for the service operation is 10 energy units, the consumed NF may associate each NF consumer with an energy credit of 1, or in the other case, associate each NF consumer of this service operation with an Energy credit of 10.

About AMF performing discovery and selection of an SMF, when the AMF receives a PDU session establishment request, the AMF may trigger the procedure of FIG. 3 to discover an SMF. The AMF may correspond to NF-2 in the procedure of FIG. 3.

In step 1 of FIG. 3, the AMF may indicate to the NRF, in the Nnrf_NFDiscovery_Request service operation, that the AMF wants to discover SMFs.

In step 3 of FIG. 3, the AMF may receive NF profiles for SMFs and each NF profile may include a service specific energy consumption estimate information and a NF profile version value.

The AMF may use the service specific energy consumption estimate information in an SMF selection procedure (e.g., step 3 of FIG. 4). For example, the AMF may consider the types of service operations that are likely to be performed in the PDU Session and the service specific energy consumption estimate information to select an SMF. The AMF may know what operations are likely to be performed in the PDU Session based on information in the UL Non-Access Stratum (NAS) transport container that carries the PDU session establishment request. For example, the UL NAS transport container may indicate if the PDU session will be a multi-access (MA) PDU session. For example, the UL NAS transport container may include a single network slice Selection assistance information (S-NSSAI) and a data network name (DNN).

For example, the S-NSSAI and DNN may indicate to the AMF whether the PDU session will be used for sending data to and from an NEF. The AMF may then use this information to determine whether to consider the energy the specific energy consumption estimate information that is associated with the Nsmf_PDUSession_TransferMOData service operation. The Nsmf_PDUSession_TransferMOData service operation may be a service operation that is used to send data to an NEF.

The AMF or any other NF consumers can count how many times a certain service or service operation has been used, when certain input parameters in a received request (in our example UL NAS Transport container) and use this information to estimate the likelihood of using a certain service or service operations given these parameters. The AMF or other NF consumers can interact with an NWDAF function to help by providing analytics in the form of statistics or predictions about the usage of certain services or service operations. The AMF or other NF consumers may use information that is derived from these analytics to determine the most likely services or service operations to be used given certain input parameters.

The likelihood of using certain services or service operations, or the frequency of using certain services and service operations, by the AMF or other NF consumers may vary, depending on a WTRU/UE the request is about or the traffic usage pattern that characterizes this WTRU/UE. For example, for certain UEs/WTRUs, who establish a PDU session with a certain S-NSSAI and DNN, for a certain application ID, the traffic usage may be less frequent, so the use of certain service operations by the AMF will incur a certain amount of a service operation A, whereas for another UE/WTRU (or another user), or another application in the same UE/WTRU, the frequency of using the same service operation A is different. In this case, the NF may provide in the NF profile or with the NF profile information that is related to certain user/application traffic patterns (as providing NF profile for each WTRU ID may not be practical).

Once the AMF selects an SMF, the AMF may invoke a service operation of the selected SMF. For example, in step 4 of FIG. 4 the AMF may invoke a service operation of the SMF and the AMF may provide the NF profile version value to the SMF. The SMF may then provide the NF profile version value to the CHF when the SMF records the service invocation.

In step 7 of FIG. 4, the SMF may respond to the AMF's service invocation. The response from the SMF may indicate that the NF profile version value is not current and may trigger the AMF to obtain a new NF profile or perform a new SMF discovery and selection operation.

About SMF performing discovery and selection of an UPF, when the SMF receives a PDU session establishment request, the SMF will trigger the procedure of FIG. 3 to discover an UPF. The SMF may correspond to NF-2 in the procedure of FIG. 3.

In step 1 of FIG. 3, the SMF may indicate to the NRF, in the Nnrf_NFDiscovery_Request service operation, that the SMF wants to discover UPFs.

In step 3 of FIG. 3, the SMF may receive NF profiles for UPFs and each NF profile may include a service specific energy consumption estimate information and the NF profile version value.

Some of the UPF interfaces (e.g. N3, N9, N6, and N4) may be not service based interfaces. Therefore, the service specific energy consumption estimate information that is associated with a UPF might indicate an energy consumption estimate that is associated with something other than a service operation. For example, the service specific energy consumption estimate information of a UPF might be an indication of an energy estimate that is associated with a DNN, S-NSSAI, traffic type (e.g. latency requirement, data rate, ATSSS capability, or support for redundancy).

The SMF may use the service specific energy consumption estimate information in an UPF selection procedure (e.g., step 3 FIG. 4). For example, the SMF may consider the types of service operations that are likely to be performed in the PDU Session and the service specific energy consumption estimate information to select an UPF. The SMF may know what operations are likely to be performed in the PDU session based on information in the PDU session establishment request. For example, when the SMF receives the PDU session establishment request, the SMF may also receive an indication that the PDU session will be an MA PDU Session. For example, the SMF may receive a DNN and S-NSSAI when it receives the PDU Session Establishment Request.

Once the SMF selects a UPF, the SMF may send a request to the selected UPF. For example, in step 4 of FIG. 4, the SMF may send an N4 message to the UPF and the SMF may provide the NF Profile version value to the UPF.

In step 7 of FIG. 4, the UPF may respond to the SMF's request. The response from the UPF may indicate that the NF profile version value is not current and may trigger the SMF to obtain a new NF profile or perform a new UPF discovery and selection operation.

In an embodiment, a method implemented in a NF to discover specific energy consumption estimate information may comprise the below following steps.

The steps that are described in this section correspond to the actions of NF-2 in FIG. 3 and FIG. 4. An NF may perform the following below steps.

In a first step (FIG. 3 and step 2 of FIG. 4), the NF may perform a discovery operation with the NRF. During the discovery operation, the NF may receive an NF profile of a discovered NF and service specific energy consumption estimate information for the discovered NF. The NF may also receive an NF profile version value from the NRF. The NF may receive more than one NF profile and an NF profile version value for each NF profile.

In a second step (step 3 of FIG. 4), based on the information in the NF profile(s) and the service specific energy consumption estimate information, the NF may determine to invoke/request a service operation of one of the discovered NF(s). The discovered NF whose service is invoked is a selected NF.

In a third (step 4 of FIG. 4), the NF may invoke/request a service operation of the selected NF. The NF may include the NF profile version value in the service invocation message.

In a fourth step (step 7 of FIG. 4), the NF may receive a response from the selected NF. The response may indicate the number of credits that the NF was charged for the service invocation. The response may indicate that the NF profile version value is not current. The response may indicate that the NF should obtain a new NF profile for the discovered NF. The NF may be an AMF or an SMF. The discovered NF may be an SMF or a UPF. The selected NF may be an SMF or a UPF.

In an embodiment, a method implemented in a NF to register specific energy consumption estimate information, may comprise the below following steps.

The steps that are described in this section correspond to the actions of NF-1 in FIG. 2 and FIG. 4. An NF may perform the following below steps.

In a first step (FIG. 2 and step 1 of FIG. 4), the NF may perform a registration operation with the NRF. During the registration operation, the NF may transmit an NF profile and specific energy consumption estimate information to the NRF. The NF may receive, from the NRF, a message comprising information indicating an NF profile version value.

In a second step (step 4 of FIG. 4), the NF may receive a request message from a second NF to invoke a service operation of the NF. The request message may comprise information including the NF profile version value in the service invocation message.

In a third (steps 5 of FIG. 4), the NF may perform operations based on the service operation request and may transmit a message to a CHF to indicate that the second NF should be charged for the service operation. The message to the CHF may indicate the number of energy credits that the second NF should be charged, and the number of credits corresponds the number of energy credits that was indicated in the service specific energy consumption estimate information.

In a fourth (step 7 of FIG. 4), the NF may transmit a response message to the second NF.

The response message may comprise information indicating the number of credits that the second NF was charged for the service invocation. The response message may comprise information indicating that the second NF profile version value is not current. The response message may comprise information indicating that the second NF should obtain a new NF Profile for the NF.

The NF may be an SMF or an UPF. The second NF may be an AMF or an SMF.

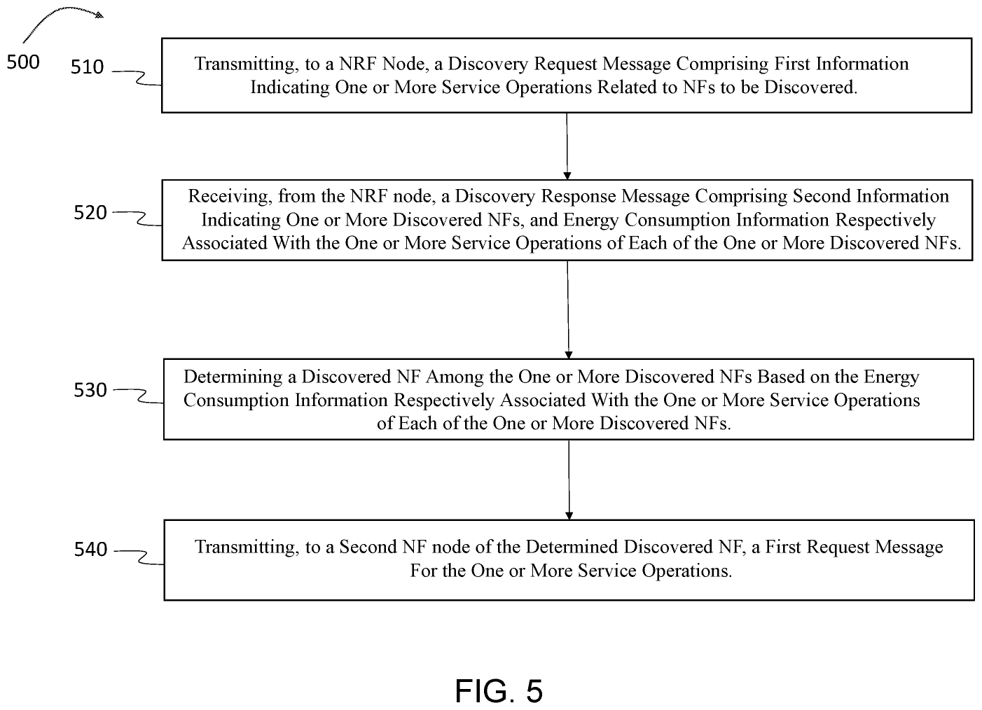

Referring to FIG. 5, a method 500, implemented in a first network function (NF) node, for discovering a network function (NF), may comprise a step wherein the first NF node may transmit 510, to a network repository function (NRF) node, a discovery request message comprising first information indicating one or more service operations related to NFs to be discovered. The method 500, may further comprise a step wherein the first NF node may receive 520, from the NRF node, a discovery response message comprising second information indicating one or more discovered NFs, and energy consumption information respectively associated with the one or more service operations of each of the one or more discovered NFs. The energy consumption information respectively associated with the one or more service operations of each of the one or more discovered NFs may correspond to an estimate of the energy consumption that will result when the one or more service operations of a discovered NF of the one or more discovered NFs is invoked. The second information may further indicate NF profiles respectively associated with the one or more discovered NF. The NF profiles respectively associated with the one or more discovered NFs may comprise the identities of the one or more discovered NFs. The method 500, may further comprise a step, wherein the first NF node may determine 530 a discovered NF among the one or more discovered NFs based on the energy consumption information respectively associated with the one or more service operations of each of the one or more discovered NFs. Determining the discovered NF among the one or more discovered NFs may be further based on the NF profiles respectively associated with the one or more discovered NFs. The method 500 may further comprise a step wherein the first NF node may transmit 540, to a second NF node of the determined discovered NF, a first request message for the one or more service operations. The transmitted first request message, to the second NF node of the discovered NF, for the one or more service operations may further comprise third information indicating an energy consumption information associated with the one or more service operations of the discovered NF.

The method 500 may further comprise a step wherein the first NF node may transmit to the NRF node, a message comprising information indicating a request for a subscription to receive notifications from the NRF node when the energy consumption information associated with the one or more service operations of the discovered NF changes.

In an embodiment, the method 500 may comprise a step wherein the first NF node may receive, from the second NF node of the discovered NF, a first response message comprising fourth information indicating a number of credits associated with the energy consumption information associated with the one or more service operations of the discovered NF.

In an embodiment, the method 500 may comprise a step wherein the first NF node may receive, from the second NF node of the discovered NF, a second response message comprising sixth information indicating that the energy consumption information associated with the one or more service operations of the discovered NF is out of date. The method 500 may further comprise a step wherein the first NF node may transmit, to the NRF node, a second request message for an update of the energy consumption information associated with the one or more service operations of the discovered NF.

In various embodiments, the first NF node may comprise an access and mobility management function or a session management function.

In various embodiments, the discovered NF function of the second NF node may be a user plane function or a session management function.

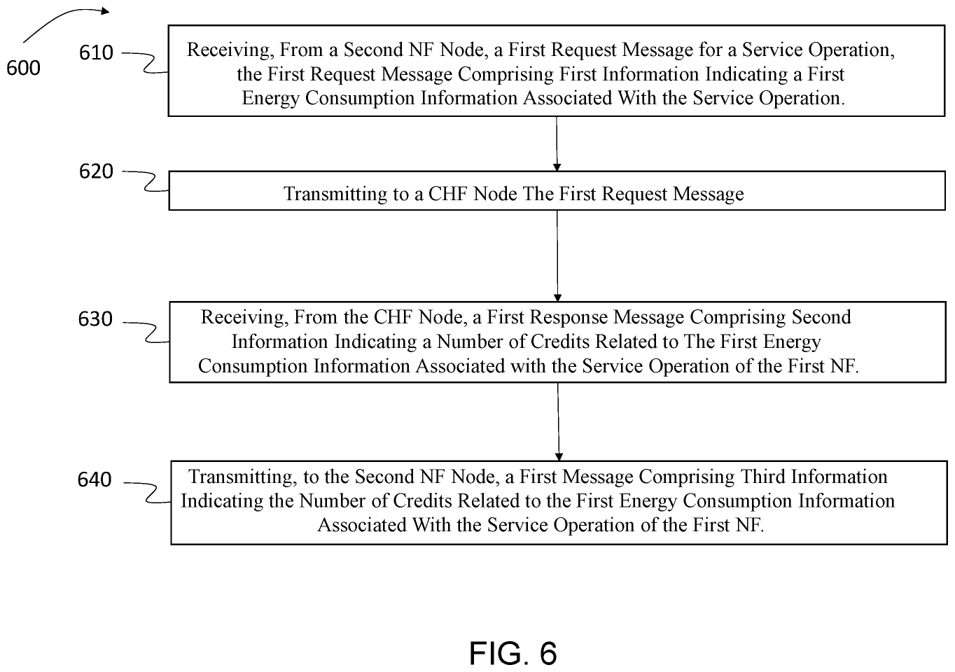

Referring to FIG. 6, a method 600, implemented in a first NF node for indicating, to a second NF node, charge for a service operation, may comprise a step wherein the first NF node may receive 610, from a second NF node, a first request message for a service operation, the first request message comprising first information indicating a first energy consumption information associated with the service operation. The method 600, may further comprise a step wherein the first NF may transmit 620 to a charging function (CHF) node the first request message. The method 600, may further comprise a step wherein the first NF may receive 630, from the CHF node, a first response message comprising second information indicating a number of credits related to the first energy consumption information associated with the service operation of the first NF; and a step wherein the first NF node may transmit 640, to the second NF node, a first message comprising third information indicating the number of credits related to the first energy consumption information associated with the service operation of the first NF.

The method 600, may further comprise a step wherein the first NF node may receive, from the second NF node, a second message comprising fourth information indicating a second energy consumption information associated with the service operation, wherein the second energy consumption information differs from the first energy consumption information; and a step wherein the first NF node may transmit, to the second NF node, a third message comprising fifth information indicating that second energy consumption information is out of date.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented in a first network function (NF) node, the method comprising:
transmitting, to a network repository function (NRF) node, a discovery request message comprising first information indicating one or more service operations related to NFs to be discovered;
receiving, from the NRF node, a discovery response message comprising second information indicating one or more discovered NFs, and energy consumption information respectively associated with the one or more service operations of each of the one or more discovered NFs;
determining a discovered NF among the one or more discovered NFs based on the energy consumption information respectively associated with the one or more service operations of each of the one or more discovered NFs; and
transmitting, to a second NF node of the determined discovered NF, a first request message for the one or more service operations.

2. The method of claim 1, wherein the transmitted first request message, to the second NF node of the discovered NF, for the one or more service operations comprises third information indicating an energy consumption information associated with the one or more service operations of the discovered NF, the method comprising
receiving, from the second NF node of the discovered NF, a first response message comprising fourth information indicating a number of credits associated with the energy consumption information associated with the one or more service operations of the discovered NF.

3. The method of claim 1, wherein the transmitted first request message, to the second NF node of the discovered NF, for the one or more service operations comprises fifth information indicating an energy consumption information associated with the one or more service operations of the discovered NF, the method comprising:
receiving, from the second NF node of the discovered NF, a second response message comprising sixth information indicating that the energy consumption information associated with the one or more service operations of the discovered NF is out of date; and
transmitting, to the NRF node, a second request message for an update of the energy consumption information associated with the one or more service operations of the discovered NF.

4. The method of claim 1, comprising:
transmitting to the NRF node, a message comprising information indicating a request for a subscription to receive notifications from the NRF node when the energy consumption information associated with the one or more service operations of the discovered NF changes.

5. The method of claim 1, wherein the first NF node comprises an access and mobility management function (AMF) or a session management function (SMF).

6. The method of claim 1, wherein the discovered NF function of the second NF node is a user plane function or a session management function (SMF).

7. The method of claim 1, wherein the second information indicates NF profiles respectively associated with the one or more discovered NFs; and wherein determining the discovered NF among the one or more discovered NFs is further based on the NF profiles respectively associated with the one or more discovered NFs.

8. The method of claim 7, wherein the NF profiles respectively associated with the one or more discovered NFs comprise the identities of the one or more discovered NFs.

9. The method of claim 1, wherein the energy consumption information respectively associated with the one or more service operations of each of the one or more discovered NFs corresponds to an estimate of the energy consumption that will result when the one or more service operations of a discovered NF of the one or more discovered NFs is invoked.

10. A first network function (NF) node, configured to:
transmit, to a network repository function (NRF) node, a discovery request message comprising first information indicating one or more service operations related to NFs to be discovered;
receive, from the NRF node, a discovery response message comprising second information indicating one or more discovered NFs, and energy consumption information respectively associated with the one or more service operations of each of the one or more discovered NFs;
determine a discovered NF among the one or more discovered NFs based on the energy consumption information respectively associated with the one or more service operations of each of the one or more discovered NFs; and
transmit, to a second NF node of the determined discovered NF, a first request message for the one or more service operations.

11. The first NF node of claim 10, wherein the first request message, comprises third information indicating an energy consumption information associated with the one or more service operations of the discovered NF, the first NF node configured to
receive, from the second NF node of the discovered NF, a first response message comprising fourth information indicating a number of credits associated with the energy consumption information associated with the one or more service operations of the discovered NF.

12. The first NF node of claim 10, wherein the first request message, comprises fifth information indicating an energy consumption information associated with the one or more service operations of the discovered NF, the first NF node configured to
receive, from the second NF node of the discovered NF, a second response message comprising sixth information indicating that the energy consumption information associated with the one or more service operations of the discovered NF is out of date; and
transmit, to the NRF node, a second request message for an update of the energy consumption information associated with the one or more service operations of the discovered NF.

13. The first NF node of claim 10, configured to
transmit to the NRF node, a message comprising information indicating a request for a subscription to receive notifications from the NRF node when the energy consumption information associated with the one or more service operations of the discovered NF changes.

14. The first NF node of claim 10 comprising an access and mobility management function (AMF) or a session management function (SMF).

15. The first NF node of claim 10, wherein the discovered NF function of the second NF node is a user plane function or a session management function, SMF.

16. The first NF node of claim 10, wherein the second information indicates NF profiles respectively associated with the one or more discovered NFs; configured to further determine the discovered NF among the one or more discovered NFs based on the NF profiles respectively associated with the one or more discovered NFs.

17. The first NF node of claim 16, wherein the NF profiles respectively associated with the one or more discovered NFs comprise the identities of the one or more discovered NFs.

18. The first NF node of claim 10, wherein the energy consumption information respectively associated with the one or more service operations of each of the one or more discovered NFs corresponds to an estimate of the energy consumption that will result when the one or more service operations of a discovered NF of the one or more discovered NFs is invoked.

19. A method, implemented in a first network function (NF) node, the method comprising:
receiving, from a second NF node, a first request message for a service operation, the first request message comprising first information indicating a first energy consumption information associated with the service operation;
transmitting to a charging function (CHF) node the first request message;
receiving, from the CHF node, a first response message comprising second information indicating a number of credits related to the first energy consumption information associated with the service operation of the first NF; and
transmitting, to the second NF node, a first message comprising third information indicating the number of credits related to the first energy consumption information associated with the service operation of the first NF.

20. The method of claim 19, comprising:
receiving, from the second NF node, a second message comprising fourth information indicating a second energy consumption information associated with the service operation, wherein the second energy consumption information differs from the first energy consumption information; and
transmitting, to the second NF node, a third message comprising fifth information indicating that second energy consumption information is out of date.
